(19) United States
(12) Patent Application Publication
(10) Pub. No.: US 2024/0160142 A1
(43) Pub. Date: May 16, 2024

(54) IMAGE FORMING APPARATUS

(71) Applicant: FUJIFILM Business Innovation Corp., Tokyo (JP)

(72) Inventors: Tomohisa SUZUKI, Kanagawa (JP); Yutaka KIUCHI, Kanagawa (JP); Daisuke NAKAI, Kanagawa (JP)

(73) Assignee: FUJIFILM Business Innovation Corp., Tokyo (JP)

(21) Appl. No.: 18/326,660

(22) Filed: May 31, 2023

(30) Foreign Application Priority Data
Nov. 16, 2022 (JP) 2022-183598

(51) Int. Cl. G03G 15/00; G03G 15/16

(52) U.S. Cl. CPC G03G 15/5041; G03G 15/161; G03G 2215/00059; G03G 2215/00063; G03G 2215/047

(57) ABSTRACT

An image forming apparatus includes: multiple image carriers holding developers; multiple potential detectors that are mounted in a first scanning direction on each of the image carriers and detect surface potentials of the image carriers; an intermediate transfer body to which the developers held by the image carriers are transferred; and multiple density detectors that are mounted in the first scanning direction of the intermediate transfer body and detect densities of the developers transferred to the intermediate transfer body. A subset of the potential detectors is mounted at a location corresponding to a location where the density detectors are mounted and a subset of the potential detectors is mounted at a location that is common to the image carriers.

### CROSS-REFERENCE TO RELATED APPLICATIONS

This application is based on and claims priority under 35 USC 119 from Japanese Patent Application No. 2022-183598 filed Nov. 16, 2022.

### BACKGROUND

### (i) Technical Field

The present disclosure relates to an image forming apparatus.

### (ii) Related Art

Japanese Examined Patent Application Publication No. 57-057703 discloses an image forming apparatus that includes multiple detection electrodes that are mounted, in a width direction of an electrostatic latent image carrier, facing the electrostatic latent image carrier and are selectively switched between when a size-A document is copied and when a size-B document is copied.

The image forming apparatus performs gradation correction on each image former to achieve a target gradation. A density detection sensor detecting a density of a test image copied onto an intermediate transfer body is mounted and the gradation correction is thus performed in accordance with the detected density. An image forming apparatus having multiple image formers forms a test image for density detection on each of the image formers and detects a density with the density detection sensor. This may involve longer time for the gradation correction in response to the number of image formers.

Variations between potentials of image carriers, such as photoconductor drums in the image formers, may be controlled to control variations in the densities of the image formers.

### SUMMARY

Aspects of non-limiting embodiments of the present disclosure relate to providing an image forming apparatus that results in shorter time for gradation correction of multiple image formers than when a single density detector is used and that includes the image formers that have common corresponding locations for potential measurement to measure potential variations between the image carriers in the image formers.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: multiple image carriers holding developers; multiple potential detectors that are mounted in a first scanning direction on each of the image carriers and detect surface potentials of the image carriers; an intermediate transfer body to which the developers held by the image carriers are transferred; and multiple density detectors that are mounted in the first scanning direction of the intermediate transfer body and detect densities of the developers transferred to the intermediate transfer body, wherein a subset of the potential detectors is mounted at a location corresponding to a location where the density detectors are mounted and a subset of the potential detectors is mounted at a corresponding location that is common to the image carriers.

### BRIEF DESCRIPTION OF THE DRAWINGS

Exemplary embodiment of the present disclosure will be described in detail based on the following figures, wherein:

FIG. 1 illustrates a configuration of an image forming apparatus according to an exemplary embodiment of the disclosure;

FIG. 2 illustrates a configuration of an image forming unit;

FIG. 3 illustrates a control configuration of the image forming apparatus according to the exemplary embodiment of the disclosure;

FIG. 4 illustrates an example of a graph obtained when a variation in a surface potential of a photoconductor drum with respect to a toner coverage is measured by a potential sensor;

FIG. 5 illustrates an example of a graph obtained when a variation in a density value of a patch image with respect to a toner coverage is measured by density sensors;

FIG. 6 illustrates a comparison example of how a first setup is performed using a single density sensor;

FIG. 7 is a perspective view illustrating a location where a potential sensor is mounted in each of the photoconductor drums; and

FIG. 8 illustrates a relationship of a mounting location of the density sensor, location where the patch image for each color is formed, and mounting location of the potential sensor in each photoconductor drum.

### DETAILED DESCRIPTION

Embodiment of the disclosure is described with reference to the drawings.

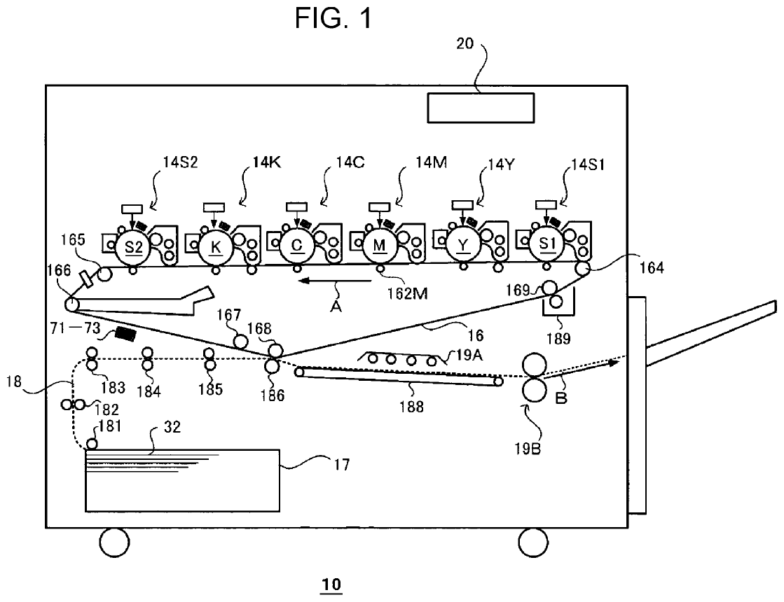

FIG. 1 illustrates a configuration of an image forming apparatus 10 of an exemplary embodiment of the disclosure.

Referring to FIG. 1, the image forming apparatus 10 of the exemplary embodiment is a large printer for commercial printing for large paper sheet and includes image forming units 14S1, 14K, 14C, 14M, 14Y, and 14S2, intermediate transfer belt 16, paper tray 17, sheet transport path 18, fixing devices 19A and 19B, and image processing apparatus 20.

The image forming apparatus 10 includes multiple image forming units 14 arranged respectively for colors images. According to the exemplary embodiment, the image forming unit 14S1, image forming unit 14K, image forming unit 14C, image forming unit 14M, image forming unit 14Y, and image forming unit 14S2 are mounted respectively for special color 1 (S1), black (K), cyan (C), magenta (M), yellow (Y), and special color 2 (S2) with constant space intervals therebetween along the intermediate transfer belt 16. The special colors herein refer to colors, such as golden, silver, transparent, and white other than standard colors, such as YMCK colors.

The image forming units 14S1, 14K, 14C, 14M, 14Y, and 14S2 having a configuration common to the colors may be simply respectively referred to as the image forming unit 14 without letters S1, K, C, M, Y, and S2 indicating colors.

The intermediate transfer belt 16 serving as an intermediate transfer body moves in the direction of an arrow A, and the six image forming units 14S1, 14K, 14C, 14M, 14Y, and 14S2 successively form toner images thereof in response to image data input from the image processing apparatus 20, and transfer the toner images onto the intermediate transfer belt 16 in a first transfer operation at timings of the overlapping of the toner images. The color order of the image forming units 14S1, 14K, 14C, 14M, 14Y, and 14S2 are not limited to the color order illustrated in FIG. 1 and the image forming units 14S1, 14K, 14C, 14M, 14Y, and 14S2 may be mounted in a different order.

The sheet transport path 18 is mounted below the intermediate transfer belt 16. A recording paper sheet 32 fed from the paper tray 17 is transported on the sheet transport path 18, the toner images transferred onto the intermediate transfer belt 16 are transferred at a time onto the recording paper sheet 32 in a second transfer operation, the transferred toner image is then fixed onto the recording paper sheet 32 by the fixing devices 19A and 19B, and the recording paper sheet 32 with the transferred toner image is then discharged to the outside along an arrow B.

The configuration of the image forming apparatus 10 is described in greater detail.

The image forming units 14S1, 14K, 14C, 14M, 14Y, and 14S2 serving image formers are mounted side by side in a horizontal direction with constant space intervals therebetween and are substantially identical in configuration to each other except that the colors of the formed images are different. In the following discussion, only the image forming unit 14K forming a K-color image is described.

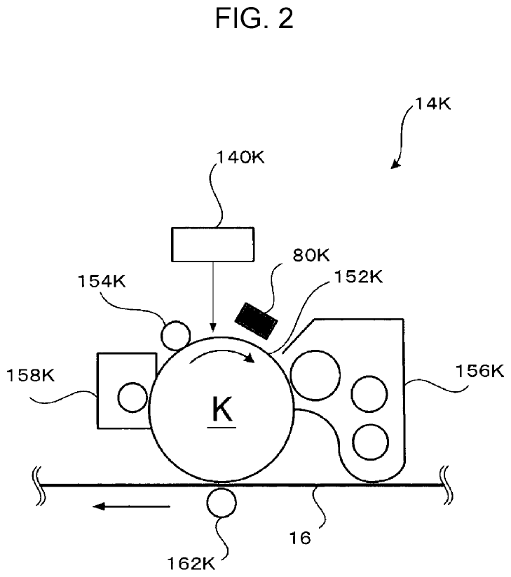

Referring to FIG. 2, the image forming unit 14K includes an exposure device 140K, photoconductor drum 152K, charging device 154K, developing device 156K, cleaning device 158K, potential sensor 80K measuring the surface potential of the photoconductor drum 152K, and first transfer roller 162K.

Three potential sensors 80K are mounted in a first scanning direction of the photoconductor drum 152K and serve as a potential detection unit that detects the surface potential of the photoconductor drum 152K holding a toner image as a developer. The first scanning direction herein refers to a direction that is perpendicular to the transport direction of the paper sheet.

The charging device 154K uniformly charges the surface of the photoconductor drum 152K. The exposure device 140K is an optical scanner or light-emitting diode (LED) print head, which causes laser light to scan the surface of the photoconductor drum 152K. The exposure device 140K radiates, onto the surface of the photoconductor drum 152K, light responsive to image data input from the image processing apparatus 20. The light radiated from the exposure device 140K forms an electrostatic latent image on the surface of the photoconductor drum 152K.

The developing device 156K develops a toner image in accordance with an electrostatic latent image formed on the photoconductor drum 152K using a developer, such as toner. The photoconductor drum 152K rotates in the direction of the arrow A at a specific speed and functions as an image carrier that holds the toner image as the developer.

The photoconductor drum 152K is uniformly charged by the charging device 154K and the light radiated from the exposure device 140K forms the electrostatic latent image on the photoconductor drum 152K. The electrostatic latent image formed on the photoconductor drum 152K is formed into the toner image with the toner of black (K) by the developing device 156K and then transferred to the intermediate transfer belt 16. Residual toner and paper dust sticking to the photoconductor drum 152K after the transfer operation of the toner image are removed by the cleaning device 158K.

The other image forming units 14S2, 14C, 14M, 14Y, and 14S1 also respectively form the toner images of the special color 2 (S2), cyan (C), magenta (M), yellow (Y), and special color 1 (S1), and transfer the formed toner images to the intermediate transfer belt 16.

The intermediate transfer belt 16 is entrained at a specific tension about a driving roller 164, idle roller 165, steering roller 166, idle roller 167, backup roller 168, and idle roller 169. The driving roller 164 rotated by a drive motor (not illustrated) causes the intermediate transfer belt 16 to be entrained in the direction of the arrow A at a specific speed. The intermediate transfer belt 16 is manufactured of flexible synthetic resin film, such as polyimide film. Both ends of the synthetic resin film are connected through welding to form the intermediate transfer belt 16 as an endless belt.

First transfer rollers 162S2, 162K, 162C, 162M, 162Y, and 162S1 are respectively mounted to be opposed to the image forming units 14S2, 14K, 14C, 14M, 14Y, and 14S1 with the intermediate transfer belt 16 interposed therebetween, and the toner images respectively formed on the photoconductor drums 152S2, 152K, 152C, 152M, 152Y, and 152S1 are thus transferred in a multiple-transfer fashion onto the intermediate transfer belt 16 via these first transfer rollers 162. Residual toner sticking to the intermediate transfer belt 16 is removed by a cleaning blade or brush of a belt cleaning device 189 mounted downstream of a second transfer position.

Elements mounted along the sheet transport path 18 include a feeder roller 181 that picks up the recording paper sheet 32 from the paper tray 17, pairs of paper transport rollers 182, 183, and 184, and registration rollers 185 that transport the recording paper sheet 32 to the second transfer position at a predetermined timing.

A second transfer roller 186 pressed in contact with a backup roller 168 is mounted at the second transfer position on the sheet transport path 18 and the toner images transferred in the multiple fashion onto the intermediate transfer belt 16 are transferred onto the recording paper sheet 32 through a pressure contact force by the second transfer roller 186 and electrostatic force. The recording paper sheet 32 having the transferred toner images is transported to the fixing devices 19A and 19B by a transport belt 188.

The fixing devices 19A and 19B perform a heating operation and a pressure operation on the recording paper sheet 32 having the transferred toner images thereon, thereby fusing toner to fix the toner images to the recording paper sheet 32.

Three density sensors 71 through 73 are mounted downstream of the image forming units 14 along the intermediate transfer belt 16. The density sensors 71 through 73 are mounted in the first scanning direction of the intermediate transfer belt 16 and serve as density detectors that detect the density of a toner image transferred to the intermediate transfer belt 16. If density detection is performed to perform gradation correction, a patch image for the density detection is formed as a test image on the intermediate transfer belt 16 and the density sensors 71 through 73 are designed to detect the density of the patch image.

Multiple potential sensors 80 described with reference to FIG. 2, for example, three potential sensors 80, are mounted in the first scanning direction for each of the six image forming units 14S2, 14K, 14C, 14M, 14Y, and 14S1 and detect the surface potentials of the image forming units 14S2, 14K, 14C, 14M, 14Y, and 14S1. Locations where the potential sensors 80 are mounted on each of the six image forming units 14S2, 14K, 14C, 14M, 14Y, and 14S1 are described below.

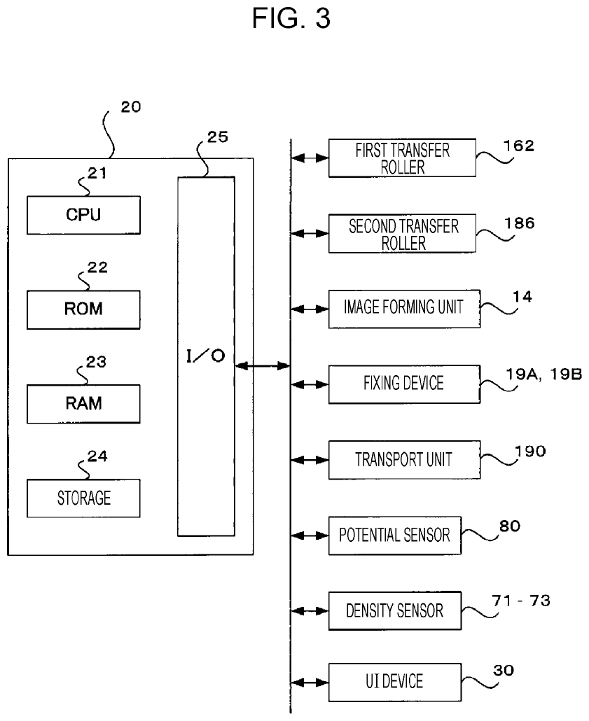

FIG. 3 illustrates a control configuration of the image forming apparatus 10 of the exemplary embodiment.

Referring to FIG. 3, the image processing apparatus 20 includes a central processing unit (CPU) 21, read-only memory (ROM) 22, random-access memory (RAM) 23, storage 24, such as a hard disk drive, and input-output (I/O) interface 25 that outputs data to or receives data from a variety of apparatuses via a network. These elements are interconnected to each other via a control bus.

The I/O interface 25 is connected to a first transfer roller 162, second transfer roller 186, image forming unit 14, fixing devices 19A and 19B, transport unit 190, potential sensors 80, density sensors 71 through 73, and user interface (UI) device 30 that includes a keyboard and a touch panel or a liquid-crystal display. The transport unit 190 includes a variety of rollers moving the intermediate transfer belt 16 and a drive motor that drives paper rollers transporting the recording paper sheet 32.

The CPU 21 controls the operation of the image forming apparatus 10 by executing specific processes in accordance with a control program saved on the ROM 22 or the storage 24. According to the exemplary embodiment, the CPU 21 reads the control program from the ROM 22 or storage 24 and executes the read control program. The control program may also be saved on a recording medium, such as a compact disc read-only memory (CD-ROM), and then delivered to the CPU 21.

The UI device 30 is controlled by the image processing apparatus 20 and displays a variety of information on a display and operation unit mounted on the image forming apparatus 10 or a display screen of a terminal apparatus.

The image processing apparatus 20 uses the surface potential of a photoconductor drum 152 of the image forming unit 14 detected by the potential sensor 80 and the density value of the patch image on the intermediate transfer belt 16 detected by the density sensors 71 through 73. Using the detected surface potential and density value, the image processing apparatus 20 performs setups to set, to a target value, the gradation of an image to be formed.

The setups include a first setup and a second setup. In the first setup, the surface potential of the photoconductor drum 152 of each color detected by the potential sensor 80 is adjusted and gradation correction is performed using the density values of the patch images detected by the density sensors 71 through 73. In the second setup, only the surface potential of the photoconductor drum 152 of each color detected by the potential sensor 80 is adjusted.

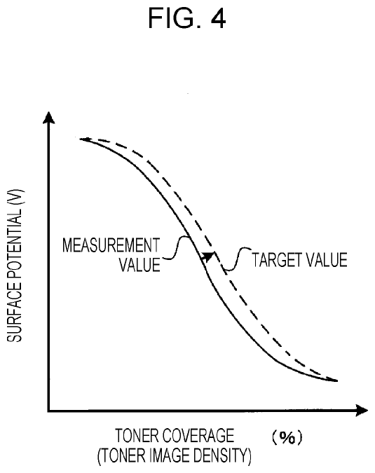

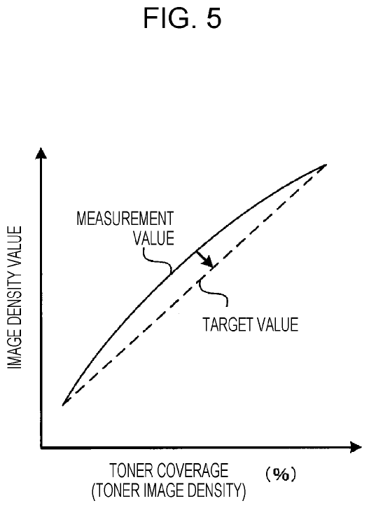

As illustrated in FIG. 4, in the first setup, a variation in the surface potential of the photoconductor drum 152 responsive to a toner coverage is measured by the potential sensor 80 and an adjustment is performed such that the variation reaches the target value. The toner coverage is a value representing a coverage of toner wherein the toner coverage is 100% if an area of interest is fully covered with toner without gaps in a toner image. In the toner image, sizes and density of dots and thickness of lines represent the gradation. According to the exemplary embodiment, the term toner coverage is also used to represent the state of a latent image before the latent image is developed with toner. After the surface potential of the photoconductor drum 152 is adjusted, the variations in the density values of the patch image with respect to the toner coverage are measured by the density sensors 71 through 73 and a correction lookup table (LUT) is generated such that the variations reach a target value as illustrated in FIG. 5. When an image of each color is formed by the image forming unit 14, correction is made using the generated LUT and target gradation characteristics thus result.

In the first setup, multiple patch images different in toner coverage may be formed on the intermediate transfer belt 16 and the densities of the formed patch images may be detected by the density sensors 71 through 73. This operation may be performed on a per color basis in order to perform the gradation correction on the image forming unit 14 of each color. Further in the first setup, it may take time for the patch image formed by the image forming unit 14 of each color on the intermediate transfer belt 16 to move a location where the density sensors 71 through 73 are enabled to perform density detection.

In contrast, in the second setup, an adjustment is simply made such that the surface potential of the photoconductor drum 152 of each color reaches a target value. The second setup is free from forming the toner image and may thus be finished in a shorter period of time.

The time period for the first setup is thus longer than the time period for the second setup.

In a comparison example described below, only a single density sensor detecting the density of the patch image on the intermediate transfer belt 16 is used.

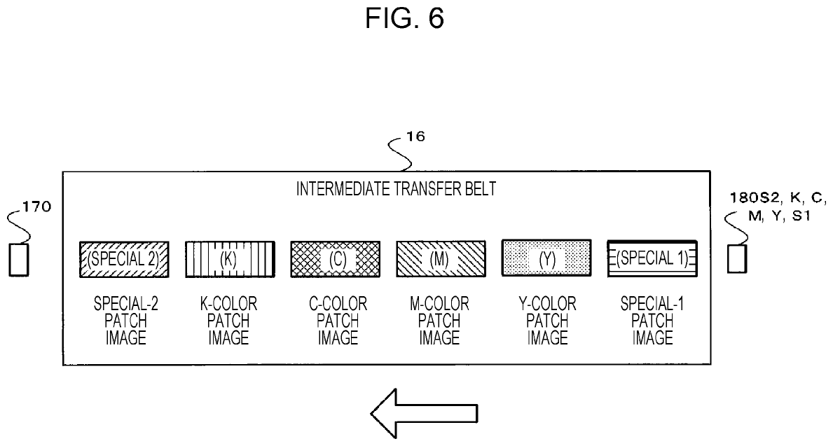

FIG. 6 illustrates the comparison example in which the first setup is performed using only a single density sensor 170.

Referring to FIG. 6, only the single density sensor 170 is used. The image forming units 14 form the patch images at the center of the intermediate transfer belt 16 where the density sensor 170 is able to detect the densities. If the patch images of different colors overlap each other on the intermediate transfer belt 16, the density detection is difficult. The image forming units 14 may thus be controlled such that the patch images are formed at different timings.

Referring to FIG. 6, a single patch image is formed for each color. In practice, however, on each of multiple toner coverages of 10%, 20%, 30%, . . . , 100%, patch images are respectively formed for the colors.

To perform the first setup in this configuration, a potential sensor 180 is simply mounted at a central location of each image forming unit 14 where the patch image is formed.

When the setup is performed on the image forming units 14 with a single density sensor, the image forming units 14 may form the patch images on the same location of the intermediate transfer belt 16. This involves in operating the image forming units 14 at different timings, leading to longer setup time.

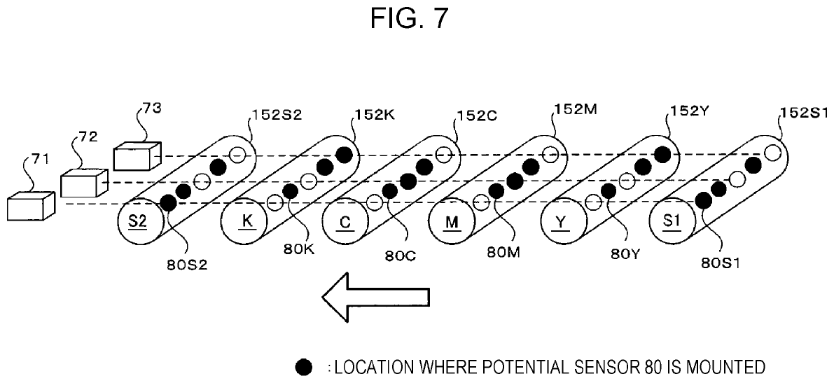

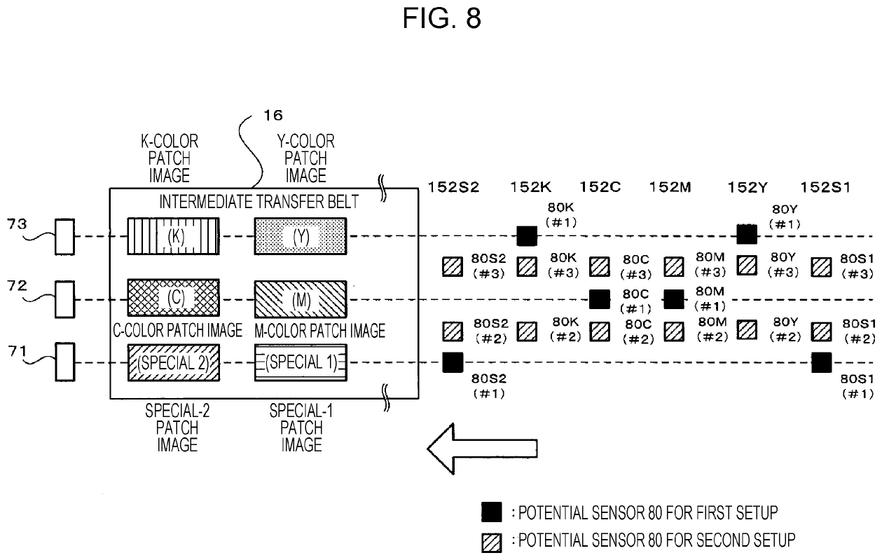

The image forming apparatus 10 of the exemplary embodiment thus includes the density sensors 71 through 73 in the first scanning direction, namely, along the axial direction of the image forming unit 14 as illustrated in FIGS. 7 and 8. By arranging the three density sensors 71 through 73 in the first scanning direction, patch images of different colors may be formed side by side on the intermediate transfer belt 16 as illustrated in FIG. 8. The setup time may be set to be shorter than when the density measurement is performed by forming the patch image for each color.

The potential of the photoconductor drum 152 at a location where the patch image is formed may be measured in order to perform the setup by detecting the density of the patch image. If the surface potential at the location of the photoconductor drum 152 where the patch image is formed is different from a target value, a correction setup may be difficult even when the density of the patch image is measured.

If patch images are formed at different locations on each of the image forming units 14 and potential sensors are mounted at the different locations, the potential sensors are mounted at locations varied from image forming unit 14 to image forming unit 14. If the locations of the potential sensors are not uniform from image forming unit 14 to image forming unit 14, it becomes difficult to measure, at a higher accuracy, the variations in the potentials of the photoconductor drums 152 of the image forming units 14 of all the colors.

The image forming apparatus 10 of the exemplary embodiment includes multiple density sensors in the first scanning direction as described below. The image forming apparatus 10 may thus result in a shorter setup time for the gradation correction on the image forming units 14 than when a single density sensor is used and may control the potential variations between the photoconductor drums 152 at a higher accuracy.

Specifically, according to the exemplary embodiment, each image forming unit 14 includes three potential sensors 80. In each image forming unit 14, a subset of the potential sensors 80, specifically, one of the potential sensors 80 is mounted at a common corresponding location corresponding to the location where the patch image is formed.

In each image forming unit 14, a subset of the potential sensors 80, specifically, two of the potential sensors 80, are mounted at locations common to the six photoconductor drums 152.

FIG. 7 is a perspective view illustrating the locations where the potential sensors 80 are mounted at the photoconductor drum 152 of each color. Referring to FIG. 7, three potential sensors 80 are mounted on each photoconductor drum 152.

FIG. 8 illustrates the relationship of the mounting locations of the density sensors 71, location of the patch image of each color, and mounting locations of the potential sensors 80 on each photoconductor drum 152.

Referring to FIG. 8, each photoconductor drum 152 includes the three potential sensors 80 (#1 through #3). One of the three potential sensors 80 (#1) is mounted at a location corresponding to a location where the patch image is formed and two of the three potential sensors 80 (#2 and #3) are mounted at the corresponding locations of the photoconductor drums 152.

The potential sensor 80 (#1) is used in the first setup that measures the densities of the patch images by the density sensors 71 through 73. The potential sensors 80 (#2 and #3) are used in the second setup that uses only the surface potential of the photoconductor drum 152 detected by the potential sensors 80.

The surface potentials are measured at the corresponding locations of the photoconductor drums 152 in the second setup and the surface potentials are measured in the first setup at the locations where the patch images are formed.

According to the exemplary embodiment, the six photoconductor drums 152 are designed to form the images of the standard colors of cyan, magenta, yellow, and black and the images of the two special colors other than standard colors. The three density sensors 71 through 73 includes density sensors 72 and 73 used to detect the patch images of the standard colors of CMYK and the density sensor 71 used to detect the patch images of the special color 1 and special color 2. Control method may be different between the standard colors CMYK and the special colors. By differentiating the density sensor for the standard colors and the density sensor for the special colors, the control method may be used appropriately for the standard colors and special colors.

From among the density sensors 71 through 73, the density sensor 72 is mounted at the location used to detect the densities of the patch images of cyan and magenta, and the density sensor 73 is mounted at the location used to detect the densities of the patch images of yellow and black. The density sensor 71 is mounted at the location used to detect the densities of the patch images of the special color 1 and special color 2. The density sensors are selectively used in view of the characteristics that magenta and cyan have a relatively larger effect on image quality, that yellow and black have a relatively smaller effect on the image quality, and that the special colors are different from the standard colors in control method. Control may thus be performed in view of the characteristics of the colors.

The density sensor 72 used to detect the densities of the patch images of cyan and magenta is mounted at the location corresponding to the location used to detect the density of the patch image transferred to the substantially central position of the intermediate transfer belt 16. Higher accuracy gradation correction may thus be performed by controlling magenta and cyan, having a larger effect on the image quality, in accordance with the density value at the center of the photoconductor drum 152 stabilized more in the characteristics of the photoconductor drum 152.

The CPU 21 in the image processing apparatus 20 may perform the first setup and the second setup at a frequency different from a frequency of the first setup. The first setup is a gradation correction process performed based on the surface potential of the photoconductor drum 152 detected by the potential sensor 80 and the densities detected by the density sensors 71 through 73. The second setup is a restriction process of restricting the density variations of the photoconductor drums 152 in accordance with only the surface potential of the photoconductor drum 152 detected by the potential sensor 80.

The CPU 21 in the image processing apparatus 20 may perform the first setup less frequently than the second setup. As described above, the first setup is the gradation correction process performed based on the surface potential of the photoconductor drum 152 detected by the potential sensor 80 and the densities detected by the density sensors 71 through 73. The second setup is the restriction process of restricting the density variations of the photoconductor drums 152 in accordance with only the surface potential of the photoconductor drum 152 detected by the potential sensor 80.

For example, the CPU 21 may perform the gradation correction process in the first setup only once every day and once after the image forming apparatus 10 is started up and the restriction process in the second setup at predetermined time intervals, for example, every hour, or every two hours. This is because the gradation correction process in the first setup takes more time than the restriction process in the second setup. In other words, if the gradation correction process in the first setup is performed at a higher frequency, efficient printing may be possibly difficult.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming apparatus including:
multiple image carriers holding developers;
multiple potential detectors that are mounted in a first scanning direction on each of the image carriers and detect surface potentials of the image carriers;
an intermediate transfer body to which the developers held by the image carriers are transferred; and
multiple density detectors that are mounted in the first scanning direction of the intermediate transfer body and detect densities of the developer transferred to the intermediate transfer body,
wherein a subset of the potential detectors is mounted at a location corresponding to a location where the density detectors are mounted and a subset of the potential detectors is mounted at a corresponding location that is common to the image carriers.
   (((2)))

In the image forming apparatus according to (((1))), multiple image formers respectively including the image carriers are configured to form images of standard colors of cyan, magenta, yellow, and black and an image of a special color other than the standard colors, and
the density detectors include a density detector detecting the image of the standard colors and a density detector detecting the image of the special color.
   (((3)))

In the image forming apparatus according to (((1))), multiple image formers respectively including the image carriers are configured to form images of standard colors of cyan, magenta, yellow, and black and an image of a special color other than the standard colors, and
the density detectors include a first density detector, a second density detector, and a third density detector, the first density detector mounted at a location used to detect a density of each of test images of cyan and magenta, the second density detector mounted at a location used to detect a density of each of test images of yellow and black, and the third density detector mounted at a location used to detect a density of a test image of the special color.
   (((4)))

In the image forming apparatus according to (((3))), the first density detector is mounted at a location corresponding to a location used to detect a density of a test image that is transferred to a substantially central position of the intermediate transfer body.

(((5)))

The image forming apparatus according to one of (((1))) through (((4))) further including a processor configured to perform a gradation correction process and a restriction process at a frequency different from a frequency of the gradation correction process, the gradation correction process performed in accordance with a potential of the image carrier detected by the potential detector and a density detected by the density detector and the restriction process restricting a variation in the densities of the image carriers in accordance with only the potential of the image carrier detected by the potential detector.

(((6)))

In the image forming apparatus according to (((5))), the processor is configured to perform the gradation correction process less frequently than the restriction process, the gradation correction process performed in accordance with the potential of the image carrier detected by the potential detector and the density detected by the density detector and the restriction process restricting the variation in the densities of the image carriers in accordance with only the potential of the image carrier detected by the potential detector.

What is claimed is:

1. An image forming apparatus comprising:
a plurality of image carriers holding developers;
a plurality of potential detectors that are mounted in a first scanning direction on each of the image carriers and detect surface potentials of the image carriers;
an intermediate transfer body to which the developers held by the image carriers are transferred; and
a plurality of density detectors that are mounted in the first scanning direction of the intermediate transfer body and detect densities of the developers transferred to the intermediate transfer body,
wherein a subset of the potential detectors is mounted at a location corresponding to a location where the density detectors are mounted and a subset of the potential detectors is mounted at a corresponding location that is common to the image carriers.

2. The image forming apparatus according to claim 1, wherein a plurality of image formers respectively including the image carriers are configured to form images of standard colors of cyan, magenta, yellow, and black and an image of a special color other than the standard colors, and
wherein the density detectors include a density detector detecting the image of the standard colors and a density detector detecting the image of the special color.

3. The image forming apparatus according to claim 1, wherein a plurality of image formers respectively including the image carriers are configured to form images of standard colors of cyan, magenta, yellow, and black and an image of a special color other than the standard colors, and
wherein the density detectors include a first density detector, a second density detector, and a third density detector, the first density detector mounted at a location used to detect a density of each of test images of cyan and magenta, the second density detector mounted at a location used to detect a density of each of test images of yellow and black, and the third density detector mounted at a location used to detect a density of a test image of the special color.

4. The image forming apparatus according to claim 3, wherein the first density detector is mounted at a location corresponding to a location used to detect a density of a test image that is transferred to a substantially central position of the intermediate transfer body.

5. The image forming apparatus according to claim 1, further comprising a processor configured to perform a gradation correction process and a restriction process at a frequency different from a frequency of the gradation correction process, the gradation correction process performed in accordance with a potential of the image carrier detected by the potential detector and a density detected by the density detector and the restriction process restricting a variation in the densities of the image carriers in accordance with only the potential of the image carrier detected by the potential detector.

6. The image forming apparatus according to claim 5, wherein the processor is configured to perform the gradation correction process less frequently than the restriction process, the gradation correction process performed in accordance with the potential of the image carrier detected by the potential detector and the density detected by the density detector and the restriction process restricting the variation in the densities of the image carriers in accordance with only the potential of the image carrier detected by the potential detector.

7. An image forming apparatus comprising:
a plurality of image carriers holding developers;
a plurality of potential detecting means, mounted in a first scanning direction on each of the image carriers, for detecting surface potentials of the image carriers;
an intermediate transfer body to which the developers held by the image carriers are transferred; and
a plurality of density detecting means, mounted in the first scanning direction of the intermediate transfer body, for detecting densities of the developers transferred to the intermediate transfer body,
wherein a subset of the potential detecting means is mounted at a location corresponding to a location where the density detecting means are mounted and a sub set of the potential detecting means is mounted at a corresponding location that is common to the image carriers.
